(19) United States
(12) Patent Application Publication
(10) Pub. No.: US 2022/0041308 A1
(43) Pub. Date: Feb. 10, 2022

(54) METHOD FOR ESTIMATING RIGHT-UNDER POINT POSITION OF ON-ORBIT OBJECT

(71) Applicant: IHI Corporation, Tokyo (JP)

(72) Inventors: Nobuo SUGIMURA, Tokyo (JP); Taku IZUMIYAMA, Tokyo (JP); Ryu SHINOHARA, Tokyo (JP)

(73) Assignee: IHI Corporation, Tokyo (JP)

(21) Appl. No.: 17/451,881

(22) Filed: Oct. 22, 2021

Related U.S. Application Data
(63) Continuation of application No. PCT/JP2020/017555, filed on Apr. 23, 2020.

(30) Foreign Application Priority Data
Jun. 4, 2019 (JP) 2019-104291

(51) Int. Cl. B64G 3/00; B64G 1/66; B64G 1/24

(52) U.S. Cl. CPC B64G 3/00; B64G 1/242; B64G 1/66

(57) ABSTRACT

A method for estimating a right-under point position of an on-orbit object includes an imaging step of capturing an observation image of an on-orbit object, together with a known object of which an orbit is known, a first right-under point position calculation step of calculating a right-under point position with respect to a center point of the observation image, and a second right-under point position calculation step of calculating a right-under point position of the on-orbit object based on the right-under point position with respect to the center point of the observation image.

### CROSS-REFERENCE TO RELATED APPLICATIONS

This application is a Continuation Application based on International Application No. PCT/JP2020/017555, filed Apr. 23, 2020, which claims priority on Japanese Patent Application No. 2019-104291, filed Jun. 4, 2019, the contents of which are incorporated herein by reference.

### TECHNICAL FIELD

The present disclosure relates to a method for estimating a right-under point position of an on-orbit object.

### BACKGROUND

The following Patent Document 1 discloses a method for displaying the position coordinates of a geostationary satellite, and a coordinate display device using this method. In Patent Document 1, the display of the position coordinates of the geostationary satellite is performed by the following procedure. First, an image of the geostationary satellite is captured together with a star, and based on the assumption that the geostationary satellite is present at a plurality of three or more representative points of the captured image, apparent right ascension and declination values of the representative point are obtained. Further, in consideration of the fact that an observation point position is away from the right-under point position, the apparent right ascension and declination values are corrected to right ascension and declination values observed from the right-under point, and the corrected right ascension and declination values of the representative point are converted to longitude and latitude of the world coordinate system. The longitude and latitude scales of the right-under point position are added to the captured image using the converted longitude and latitude, and are displayed together with the captured image of the geostationary satellite.

### DOCUMENT OF RELATED ART

### Patent Document

### [Patent Document 1] Japanese Unexamined Patent Application, First Publication No. 2008-36009

### SUMMARY

In Patent Document 1, an orbit of the geostationary satellite which is a measurement target is determined by capturing an image of the geostationary satellite, together with the star, and the right-under point position (latitude and longitude) is obtained based on the determined orbit. That is, in Patent Document 1, it is necessary to determine the orbit of the geostationary satellite, and the right-under point position is obtained based on the orbit of the geostationary satellite. The work of determining the orbit is complicated, and a simpler method for estimating the right-under point position is required.

The present disclosure has been made in view of the above circumstances, and an object thereof is to estimate a right-under point position of an on-orbit object without obtaining an orbit of the on-orbit object.

According to an aspect of the present disclosure, a method for estimating a right-under point position of an on-orbit object includes an imaging step of capturing an observation image of an on-orbit object, together with a known object of which an orbit is known, a first right-under point position calculation step of calculating a right-under point position with respect to a center point of the observation image, and a second right-under point position calculation step of calculating a right-under point position of the on-orbit object based on the right-under point position with respect to the center point of the observation image.

According to the present disclosure, the right-under point position of the on-orbit object can be estimated without obtaining the orbit of the on-orbit object.

### BRIEF DESCRIPTION OF DRAWINGS

FIG. 1A is a schematic view showing a method for estimating a right-under point position of an on-orbit object according to one embodiment of the present disclosure.

FIG. 1B is a flowchart showing the method for estimating the right-under point position of the on-orbit object according to one embodiment of the present disclosure.

### DESCRIPTION OF EMBODIMENTS

Hereinafter, one embodiment of the present disclosure will be described with reference to the drawings.

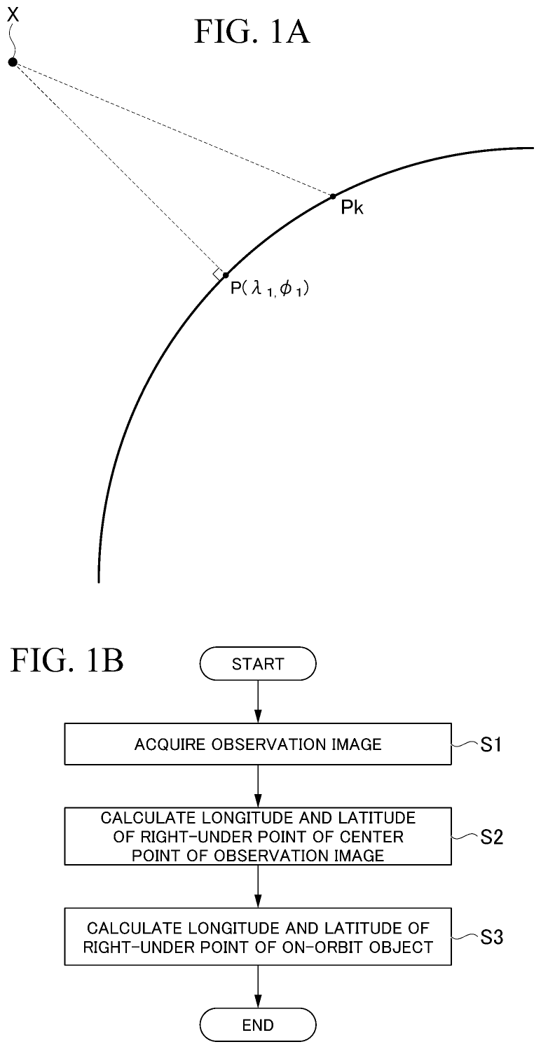

As shown in FIG. 1A, in a method for estimating a right-under point position of an on-orbit object according to the present embodiment, a right-under point position P (λ₁, φ₁) of an on-orbit object X is obtained based on an observation image of the on-orbit object X captured at a certain point (observation point Pk) on the earth.

In the method for estimating the right-under point position according to the present embodiment, the observation image is acquired using a camera installed at the observation point Pk, predetermined information processing is performed on the observation image by using a computer, and a point at which a vertical line between the on-orbit object X and the center of the earth intersects a horizontal plane on the ground surface is acquired as the right-under point position P (λ₁, φ₁).

A specific procedure for obtaining the right-under point position P (λ₁, φ₁) is shown in the flowchart of FIG. 1B. In the method for estimating the right-under point position according to the present embodiment, initially, an observation image is acquired (step S1). In step S1, a camera for capturing a still image is installed at the observation point Pk and captures an image of the on-orbit object X. At this time, the image of the on-orbit object X is captured together with an object (known object) of which an orbit is known. Step S1 corresponds to an imaging step of the present disclosure.

That is, the observation image in the present embodiment is a still image in which the on-orbit object X and the known object are imaged as subjects. The known object is, for example, a star such as the sun or an artificial satellite. In step S1, the observation image is acquired at the timing when the known object is imaged as a subject in addition to the on-orbit object X.

In the method for estimating the right-under point position according to the present embodiment, subsequently, a right-under point position P₀ (λ₁, φ₁) of a center point in the observation image is calculated (step S2). That is, in step S2, image data of the observation image is taken into a computer, and the center of the observation image having a predetermined resolution and aspect ratio is calculated as the center point. Step S2 corresponds to a first right-under point position calculation step in the present disclosure.

Here, a latitude λ₀ and a longitude φ₀ of the right-under point position P₀ (λ₁, φ₁) are expressed by the following Equations (1) and (2) by using the coordinates (xₛₐₜ, yₛₐₜ), on the observation image, of the known on-orbit object captured on the observation image. Note that “λ” in Equation (1) is the latitude of the right-under point position of the known on-orbit object, and “φ” in Equation (2) is the longitude of the right-under point position of the known on-orbit object.

$$\begin{matrix}{λ}_{0} = \frac{\begin{matrix}{cos}^{- 1} ( \frac{{y}_{sat}}{ρ sin λ \cdot sin {c}_{y}} ) + \\ cos {c}_{y} \sqrt{{cos}^{2} {c}_{y} + {( \frac{{y}_{sat}}{ρ} sin {c}_{y} )}^{2} - {sin}^{2} λ}\end{matrix}}{{cos}^{2} {c}_{y} + {( \frac{{y}_{sat}}{ρ} sin {c}_{y} )}^{2}} & ( 1 ) \\ {ϕ}_{0} = ϕ - {tan}^{- 1} ( \frac{{x}_{sat} sin {c}_{x}}{ρ cos {λ}_{0} cos {c}_{x} - {y}_{sat} sin {λ}_{0} sin {c}_{x}} ) & ( 2 )\end{matrix}$$

In addition, “cₓ” and “c_{y}” in the above Equations (1) and (2) are expressed by a quantity ρ based on radii Rₓ and R_{y} and the coordinates (xₛₐₜ, yₛₐₜ) as expressed in the following Equations (3) and (4).

$$\begin{matrix}{c}_{x} = 2 {tan}^{- 1} ( \frac{ρ}{2 {R}_{x}} ) & ( 3 ) \\ {c}_{y} = 2 {tan}^{- 1} ( \frac{ρ}{2 {R}_{y}} ) & ( 4 )\end{matrix}$$

As expressed in the following Equation (5), the quantity ρ is a quantity based on the coordinates (xₛₐₜ, yₛₐₜ) of the known on-orbit object on the observation image. In addition, the radii Rₓ and R_{y} are quantities corresponding to a radius R of a sphere in a stereo projection method, and are calculated from the image size (a width w and a height h) of the observation image and the viewing angles (a viewing angle α in a width direction and a viewing angle β in a height direction) of the camera as expressed in the following Equations (6) and (7).

$$\begin{matrix}ρ = \sqrt{{x}_{sat}^{2} + {y}_{sat}^{2}} & ( 5 ) \\ {R}_{x} = \frac{w ( 1 + cos α cos β )}{4 cos α sin β} & ( 6 ) \\ {R}_{y} = \frac{h ( 1 + cos α cos β )}{4 sin α} & ( 7 )\end{matrix}$$

Here, the image size (the width w and the height h) of the observation image are stored in advance in a storage device installed in the computer. In addition, the viewing angles of the camera are measured by a tachometer provided in a tripod or the like of the camera. That is, the viewing angle α in the width direction and the viewing angle β in the height direction are quantities obtained as measured values by the tachometer. The viewing angle α in the width direction and the viewing angle β in the height direction are input to the computer by operating an input device (for example, a keyboard) installed in the computer.

The computer calculates the radii Rₓ and R_{y} based on the image size (the width w and the height h) of the observation image stored in advance in the storage device and the viewing angles (the viewing angle α in the width direction and the viewing angle β in the height direction) of the camera input from the input device. In addition, the computer calculates the quantity ρ based on the coordinates (xₛₐₜ, yₛₐₜ) on the observation image.

Then, the computer calculates the quantities cₓ, c_{y} by substituting the radii Rₓ and R_{y} and the quantity ρ, which are calculated in the above manner, into Equations (3) and (4). Further, the right-under point position P₀ (λ₀, φ₀) with respect to the center point of the observation image is calculated by substituting the quantities cₓ and c_{y}, which are calculated in the above manner, the coordinates (xₛₐₜ, yₛₐₜ), and the latitude λ and the longitude φ of the right-under point position of the known on-orbit object into Equations (1) and (2).

In the method for estimating the right-under point position according to the present embodiment, the right-under point position P (λ₁, φ₁) of the on-orbit object X is calculated using the right-under point position P₀ (λ₀, φ₀) with respect to the center point of the observation image calculated in the above manner (step S3).

That is, in step S3, the latitude λ₁ and the longitude φ₁ of the right-under point of the on-orbit object X are calculated by substituting the right-under point position P₀ (λ₀, φ₀), which is calculated according to Equations (1) and (2), into the following Equations (8) and (9). Step S3 corresponds to a second right-under point position calculation step of the present disclosure.

$$\begin{matrix}{λ}_{1} = {sin}^{- 1} ( cos {c}_{y} sin {λ}_{0} + \frac{{y}_{1} sin {c}_{y} cos {λ}_{0}}{ρ} ) & ( 8 ) \\ {ϕ}_{1} = {ϕ}_{0} + {tan}^{- 1} ( \frac{{x}_{1} sin {c}_{x}}{ρ cos {ϕ}_{0} cos {c}_{x} - {y}_{1} sin {ϕ}_{0} sin {c}_{x}} ) & ( 9 )\end{matrix}$$

According to the present embodiment, the right-under point position of the on-orbit object X can be estimated, without obtaining the orbit of the on-orbit object X, based on the latitude λ and the longitude φ of the right-under point position of the known on-orbit object, the coordinates (xₛₐₜ, yₛₐₜ) of the known on-orbit object on the observation image, the image size of the observation image, and the viewing angles of the camera.

The present disclosure can be applied to the estimation of the right-under point position of the on-orbit object.

What is claimed is:

1. A method for estimating a right-under point position of an on-orbit object, the method comprising:
an imaging step of capturing an observation image of an on-orbit object, together with a known object of which an orbit is known;
a first right-under point position calculation step of calculating a right-under point position with respect to a center point of the observation image; and
a second right-under point position calculation step of calculating a right-under point position of the on-orbit object based on the right-under point position with respect to the center point of the observation image.
